(19) United States
(12) Patent Application Publication
(10) Pub. No.: US 2010/0060398 A1
(43) Pub. Date: Mar. 11, 2010

(54) Method to Fabricate a Molding Inductor Structure and a Molding Inductor Structure

(75) Inventor: Huo-Li LIN, Taipei City (TW)

Correspondence Address: BRIAN M. MCINNIS, 12th Floor, Ruttonjee House, 11 Duddell Street, Hong Kong, HK

(73) Assignee: TRIO TECHNOLOGY CO., LTD., TAIPEI CITY 116 (TW)

(21) Appl. No.: 12/235,576

(22) Filed: Sep. 22, 2008

(30) Foreign Application Priority Data
Sep. 8, 2008 (TW) 97134461

(51) Int. Cl. H01F 27/02; H01F 41/00

(52) U.S. Cl. 336/65; 29/607

(57) ABSTRACT

A method to fabricate a molding inductor structure and a molding inductor structure are provided. The method comprises the steps of: performing a high pressure process on a first magnetic material to form a baseboard, wherein a central area of the baseboard comprises a pillar; providing a metal coil, wherein the metal coil comprises an open coil center; connecting the metal coil and the baseboard such that the pillar lodges in the open coil center; placing the connected metal coil and the baseboard into a mold; and forming a covering structure by stuffing a second magnetic material with a high pressure process to cover the connected metal coil and the baseboard to form the molding inductor structure.

### RELATED APPLICATIONS

This application claims priority to Taiwan Application Serial Number 97134461, filed Sep. 8, 2008, which is herein incorporated by reference.

### BACKGROUND

1. Field of Invention

The present invention relates to a molding inductor structure. More particularly, the present invention relates to a method to fabricate a molding inductor structure and a molding inductor structure.

2. Description of Related Art

Inductors are important elements of electronic circuits. Inductors can be used to store and release energy. Inductors eliminate disturbance from magnetic fields therefore making them ideal for implementation in today's shrinking electronic products. Many countries are making rules to set up a standard for the inductors. The inductor has thus becomes an important element of the electronic circuits.

The conventional method to fabricate an inductor with the molding inductor structure is to directly put the coil on the top of a magnetic material into a mold and use metal powders to stuff in the mold with only one high pressure process to cover the coil. The method described above is easy to make the coil displace or deform because the coil is not fixed on the magnetic material. Besides, the high pressure process mentioned above is about 15-20 tons/square inch, the coil can't stand for such a high pressure during the process of stuffing the metal powders. Thus, there is also a limit of pressure in the above process in order not to break the metal coil to decrease the performance of the inductor.

Accordingly, what is needed is a molding inductor structure and a method for fabricating a molding inductor structure to overcome the above issues. The present invention addresses such a need.

### SUMMARY

A method to fabricate a molding inductor structure is provided. The method comprises the steps of performing a high pressure process on a first magnetic material to form a baseboard, wherein a central area of the baseboard comprises a pillar; providing a metal coil, wherein the metal coil comprises an open coil center; connecting the metal coil and the baseboard such that the pillar lodges in the open coil center; placing the connected metal coil and the baseboard into a mold; and forming a covering structure by stuffing a second magnetic material with a high pressure process to cover the connected metal coil and the baseboard to form the molding inductor structure.

Another object of the present invention is to provide a molding inductor structure comprising: a baseboard, a metal coil and a covering structure. The baseboard comprises a first magnetic material, wherein a pillar is formed in a central area of the baseboard. The metal coil comprises an open coil center and two ends, wherein the pillar of the baseboard lodges in the open coil center, and the covering structure comprises a second magnetic material covering the connected metal coil and the baseboard, wherein the two ends of the metal coil electrically connect to an outward circuit respectively.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A is a perspective view of a molding inductor structure of a first embodiment of the present invention;

FIG. 1B is an exploded view of the molding inductor structure of the first embodiment of the present invention;

FIG. 1C is a side view of the formation of the baseboard in a first stage of high pressure process in the first embodiment of the present invention;

FIG. 1D is a side view of the formation of the covering structure in a second stage of high pressure process in the first embodiment of the present invention;

FIG. 2A is a perspective view of a molding inductor structure of a second embodiment of the present invention;

FIG. 2B is an exploded view of the molding inductor structure of the second embodiment of the present invention; and

FIG. 3 is a flow chart of the method of a third embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

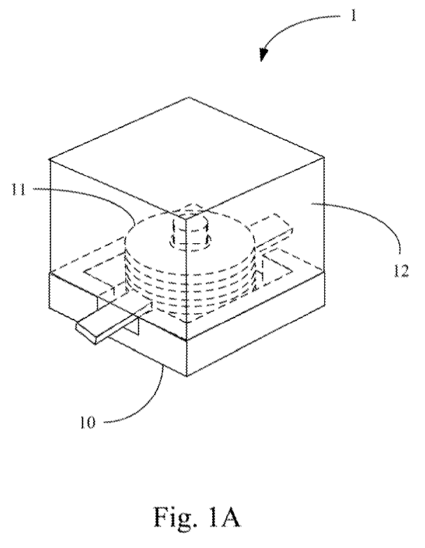

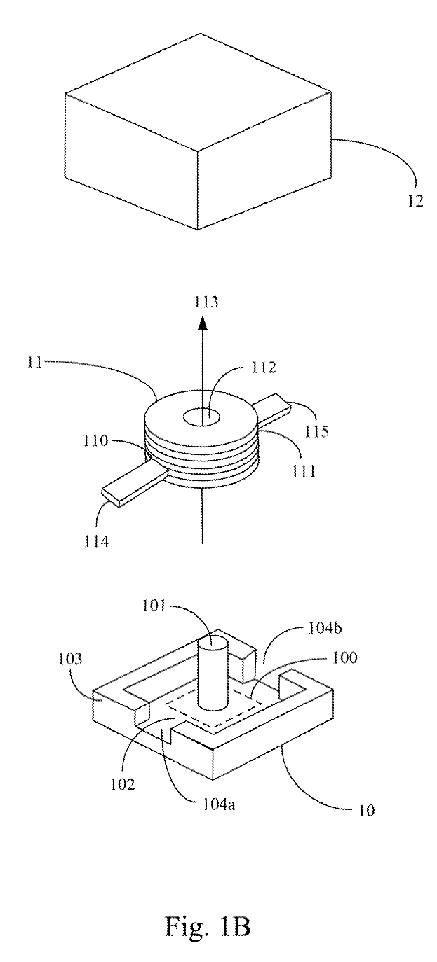

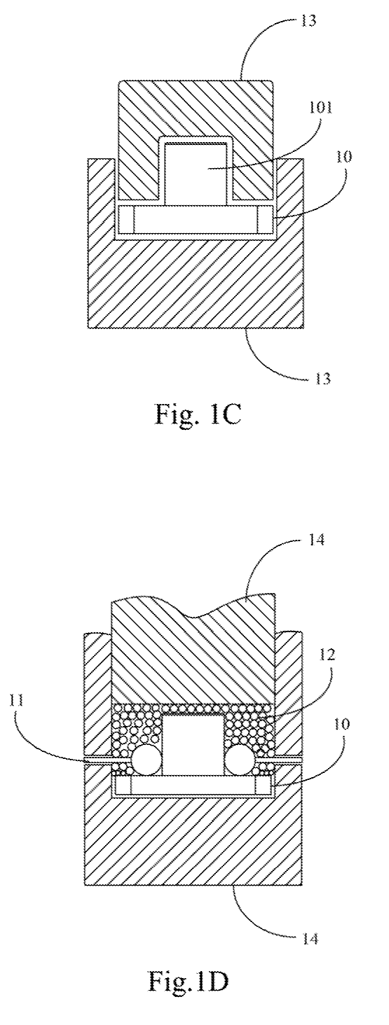

Please refer to FIG. 1A, a perspective view of a molding inductor structure 1 of a first embodiment of the present invention. The molding inductor structure 1 comprises a baseboard 10, a metal coil 11 and a covering structure 12. Please refer to FIG. 1B at the same time, an exploded view of the molding inductor structure 1. A central area 100 of the baseboard 10 comprises a pillar 101. The baseboard 10 is substantially formed by performing a first stage of high pressure process on a first magnetic material. The first magnetic material may comprises iron powders, alloy powders or non-alloy powders. The people skilled in the art can easily make various modifications. As shown in FIG. 1C, after placing the first magnetic material into a baseboard mold to form the shape of the baseboard 10, the first stage of high pressure process is performed. Therefore, a baseboard 10 of a structure comprising a plate 102 and a sidewall 103 is formed as depicted in FIG. 18. The metal coil 11 comprises two ends 110, 111 and an open coil center 112, wherein the two ends 110, 111 stretch along the direction vertical to the axis 113 of the metal coil 11. The metal coil 11 in the present embodiment is formed with a copper wire. In other embodiment, the metal coil 11 can be formed with other metal material. Also, a plurality of wires can be used to form a single metal coil structure to reinforce the inductivity. The people skilled in the art can easily make various modifications. The pillar 101 of the baseboard 10 lodges in the open coil center 11 2 of the metal coil 11. The covering structure 12 comprises a second magnetic material covering the connected metal coil 11 and the baseboard 10. The second magnetic material is a blend of a metal powders and a non-metal powders. The metal powders are iron powders or alloy powders, wherein the non-metal powders are a blend of ceramics materials, pectic materials and adhesive. The percentage of the metal and non-meta powders can be adjusted to make the second magnetic material generate an appropriate magnetic flux. After a second stage of high pressure process, the second magnetic material covers the connected metal coil 11 and the baseboard 10 to form the covering structure 12. The baseboard 10 substantially comprises two openings 104a and 104b on the sidewall 103. And each of the two ends 110, 111 of the metal coil comprises a conductive plate 114, 115 formed thereon. The two ends 110, 111 of the metal coil 11 are exposed outside of the covering structure 12 and are substantially connected to an outward circuit (not shown) through the two openings 104a, 104b with the two conductive plates 114, 115 respectively. Thus, the molding inductor structure 1 can perform the function of an inductance.

The baseboard 10 of the molding inductor structure 1 can be formed with a process over 1 ton/square inch, or even a extreme high pressure process over 30 tons/square inch. Therefore, the baseboard 10 and the pillar 101 of the baseboard 10 are both high-density structure. The baseboard 10 and the pillar 101 provides a supporting and a fixing mechanism to keep the metal coil 11 from damage, deformation or displacement during the high pressure process of the formation of the covering structure 12. Furthermore, the inductance of the molding inductor structure 1 increases a lot due to the high-density pillar 101 lodged in the open coil center 112. Thus, the design of the baseboard 10 with the pillar 101 provides a great increase on supporting mechanism, fixing mechanism and the inductance.

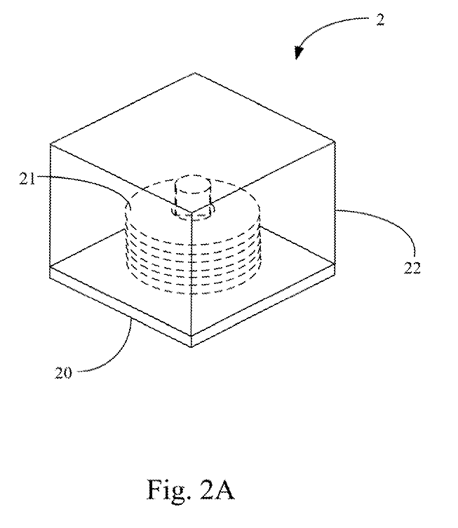

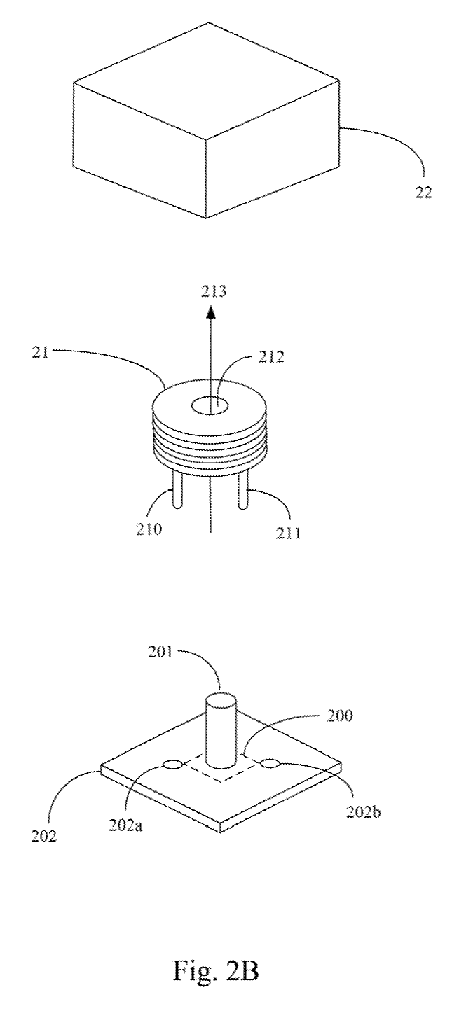

Please refer to FIG. 2A and FIG. 2B, a perspective view and an exploded view of the molding inductor structure 2 of the second embodiment of the present invention respectively. The molding inductor structure 2 comprises a baseboard 20, a metal coil 21 and a covering structure 22. In the present embodiment, the baseboard 20 is formed by performing a first stage of high pressure process on a first magnetic material as well. The baseboard 20 comprises a pillar 201 on a central area 200 of the baseboard 20 and a plate 202. Two openings 202a and 202b are formed on the baseboard 20. The metal coil 21 comprises two ends 210, 211 and an open coil center 212, wherein the two ends 210, 211 stretch along a direction parallel to the axis 213 of the metal coil 21. The pillar 201 of the baseboard 20 lodges in the open coil center 212 of the metal coil 21. The covering structure 22 comprises a second magnetic material covering the connected metal coil 21 and the baseboard 20. The two ends 210, 211 of the metal coil 21 are exposed outside of the covering structure 22 and are substantially connected to an outward circuit (not shown) through the two openings 202a, 202b with the two conductive plates 214, 215 respectively. Thus, the molding inductor structure 2 can perform the function of an inductance.

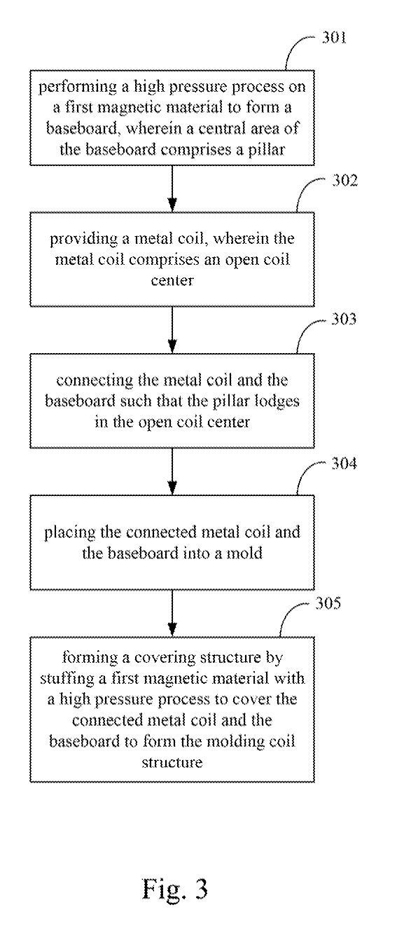

The third embodiment of the present invention is a method to fabricate a molding inductor structure. FIG. 3 is a flow chart of the method of the third embodiment, wherein the method comprises the steps of: in step 301, performing a high pressure process on a first magnetic material to form a baseboard, wherein a central area of the baseboard comprises a pillar; in step 302, providing a metal coil, wherein the metal coil comprises an open coil center; in step 303, connecting the metal coil and the baseboard such that the pillar lodges in the open coil center; in step 304, placing the connected metal coil and the baseboard into a mold; and in step 305, forming a covering structure by stuffing a second magnetic material with a high pressure process to cover the connected metal coil and the baseboard to form the molding inductor structure.

It's noticed that, the step of stuffing the second magnetic material is performed after the step of placing the connected metal coil and the baseboard into a mold in the method described above. However, in another embodiment, the people skilled in the art can easily make the modification that performing the step of stuffing the second magnetic material in to a mold second, then performing the step of placing the connected metal coil and the baseboard into the mold to cover the second magnetic material. Then after performing the high pressure process, the molding inductor structure is formed. The only difference is that the baseboard of the previous embodiment becomes a “top board” in the present embodiment.

According to the embodiments described above, the baseboard with the pillar formed by a first stage of high pressure process can provides a better supporting and fixing mechanism to prevent the metal coil from the damage or deformation during the second stage of high pressure process of the formation of the covering structure. Thus, the method increases the yield of the fabrication process of the molding inductor structure. On the other side, the high density pillar of the baseboard further increases the magnetic flux of the metal coil and further increases the inductance of the whole molding inductor structure.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method to fabricate a molding inductor structure comprising the steps of:
performing a high pressure process on a first magnetic material to form a baseboard, wherein a central area of the baseboard comprises a pillar;
providing a metal coil, wherein the metal coil comprises an open coil center;
connecting the metal coil and the baseboard such that the pillar lodges in the open coil center;
placing the connected metal coil and the baseboard into a mold; and
forming a covering structure by stuffing a second magnetic material with a high pressure process to cover the connected metal coil and the baseboard to form the molding inductor structure.

2. The method of claim 1, wherein the step of forming the baseboard further comprises the steps of placing the first magnetic material in to a baseboard mold to perform the high pressure process on the first magnetic material.

3. The method of claim 1, wherein the metal coil comprises two ends exposed outside of the covering structure to electrically connect to an outward circuit respectively.

4. The method of claim 3, wherein two conductive plates are formed on the two ends of the metal coil, the two ends of the metal coil substantially connect to the outward circuit through the two conductive plates.

5. The method of claim 1, wherein the metal coil comprises two ends and the baseboard comprises two openings, the two ends of the metal coil are exposed outside of the covering structure through the two openings to electrically connect to an outward circuit respectively.

6. The method of claim 5, wherein two conductive plates are formed on the two ends of the metal coil, the two ends of the metal coil substantially connect to the outward circuit through the two conductive plates.

7. The method of claim 1, wherein the first magnetic material is a blend of a metal powders and a non-metal powders.

8. A molding inductor structure comprising:
a baseboard comprising a first magnetic material, wherein a pillar is formed in a central area of the baseboard;
a metal coil comprising an open coil center and two ends, wherein the pillar of the baseboard lodges in the open coil center; and
a covering structure comprising a second magnetic material covering the connected metal coil and the baseboard, wherein the two ends of the metal coil electrically connect to an outward circuit respectively.

9. The molding inductor structure of claim 8, wherein the baseboard is formed by performing a high pressure process on the first magnetic material.

10. The molding inductor structure of claim 8, wherein the two ends of the metal coil are exposed outside of the covering structure to electrically connect to an outward circuit respectively.

11. The molding inductor structure of claim 10, wherein two conductive plates are formed on the two ends of the metal coil, the two ends of the metal coil substantially connect to the outward circuit through the two conductive plates.

12. The molding inductor structure of claim 8, wherein the baseboard comprises two openings, the two ends of the metal coil are exposed outside of the covering structure through the two openings to electrically connect to an outward circuit respectively.

13. The molding inductor structure of claim 8, wherein the first magnetic material is a blend of a metal powders and a non-metal powders.
